(19) United States
(12) Patent Application Publication
(10) Pub. No.: US 2024/0069991 A1
(43) Pub. Date: Feb. 29, 2024

(54) ABNORMAL REQUEST PROCESSING METHOD AND APPARATUS, ELECTRONIC DEVICE AND STORAGE MEDIUM

(71) Applicant: Beijing Bytedance Network Technology Co., Ltd., Beijing (CN)

(72) Inventors: Kai WANG, Beijing (CN); Xiao ZHANG, Beijing (CN)

(21) Appl. No.: 18/256,591

(22) PCT Filed: Apr. 27, 2022
(86) PCT No.: PCT/CN2022/089484

§ 371 Date: Jun. 8, 2023

(30) Foreign Application Priority Data
Jun. 30, 2021 (CN) 202110738186.0

(51) Int. Cl. G06F 9/54

(52) U.S. Cl. CPC G06F 9/546; G06F 2209/547; G06F 2209/548

(57) ABSTRACT

Provided are an abnormal request processing method and apparatus, an electronic device and a storage medium. The method includes: acquiring a target request within a preset time period, where the target request includes a network resource identifier; querying a first queue; in the case where the first queue does not include a first request matching the network resource identifier, querying a second queue; in the case where the second queue includes a second request matching the network resource identifier, updating request data of the second request matching the network resource identifier; and at an end of the preset time period, determining request data of the target request according to the first queue or the second queue, and in the case where the request data of the target request meets a first preset condition, determining the target request to be an abnormal request.

This application claims priority to Chinese Patent Application No. 202110738186.0 filed with the China National Intellectual Property Administration (CNIPA) on Jun. 30, 2021, the disclosure of which is incorporated herein by reference in its entirety.

### TECHNICAL FIELD

The present disclosure relates to the field of information technology, for example, an abnormal request processing method and apparatus, an electronic device and a storage medium.

### BACKGROUND

With the development of information technology, terminals have become indispensable devices in people's daily life. For example, a user may install various applications (APPs) of different types and with different uses on a terminal.

Generally, in the process of the terminal running an application, network traffic may be consumed. In the development and test scenario of an application, abnormal traffic consumption may even occur, for example, relatively much traffic is consumed.

### SUMMARY

The present disclosure provides an abnormal request processing method and apparatus, an electronic device and a storage medium.

The present disclosure provides an abnormal request processing method including the steps described below.

A target request is acquired within a preset time period, where the target request includes a network resource identifier.

A first queue is queried according to the network resource identifier, where the first queue is configured to store related information of a first request within the preset time period.

In the case where the first queue does not include a first request matching the network resource identifier, a second queue is queried according to the network resource identifier, where the second queue is configured to store related information of second requests within the preset time period, and a request frequency represented by request data of a first request of the first requests is greater than a request frequency represented by request data of a second request of the second requests.

In the case where the second queue includes a second request matching the network resource identifier, request data of the second request matching the network resource identifier is updated.

At an end of the preset time period, request data of the target request is determined according to the first queue or the second queue, and in the case where the request data of the target request meets a first preset condition, the target request is determined to be an abnormal request.

The present disclosure further provides an abnormal request processing apparatus including an acquisition module, a query module, an update module and a determination module.

The acquisition module is configured to acquire a target request within a preset time period, where the target request includes a network resource identifier.

The query module is configured to query a first queue according to the network resource identifier, where the first queue is configured to store related information of first requests within the preset time period.

The query module is further configured to, in the case where the first queue does not include a first request matching the network resource identifier, query a second queue according to the network resource identifier, where the second queue is configured to store related information of second requests within the preset time period, and a request frequency represented by request data of a first request of the first requests is greater than a request frequency represented by request data of a second request of the second requests.

The update module is configured to, in the case where the second queue includes a second request matching the network resource identifier, update request data of the second request matching the network resource identifier.

The determination module is configured to, at an end of the preset time period, determine request data of the target request according to the first queue or the second queue, and in the case where the request data of the target request meets a first preset condition, determine the target request to be an abnormal request.

The present disclosure further provides an electronic device including one or more processors and a storage apparatus.

The storage apparatus is configured to store one or more programs.

The one or more programs, when executed by the one or more processors, cause the one or more processors to perform the abnormal request processing method described above.

The present disclosure further provides a computer-readable storage medium. The storage medium stores a computer program, where the computer program, when executed by a processor, implements the abnormal request processing method described above.

The present disclosure further provides a computer program product. The computer program product includes a computer program or instruction which, when executed by a processor, implements the abnormal request processing method described above.

### BRIEF DESCRIPTION OF DRAWINGS

FIG. 1 is a flowchart of an abnormal request processing method according to an embodiment of the present disclosure;

FIG. 2 is a flowchart of another abnormal request processing method according to an embodiment of the present disclosure;

FIG. 3 is a schematic diagram of the principle of a method for implementing S130 according to an embodiment of the present disclosure;

FIG. 4 is a schematic diagram of the principle of a method for implementing S150 according to an embodiment of the present disclosure;

FIG. 5 is a schematic diagram of the principle of a method for implementing S160 according to an embodiment of the present disclosure;

FIG. 6 is a flowchart of another abnormal request processing method according to an embodiment of the present disclosure;

FIG. 7 is a structure diagram of an abnormal request processing apparatus according to an embodiment of the present disclosure; and

FIG. 8 is a structure diagram of an electronic device according to an embodiment of the present disclosure.

### DETAILED DESCRIPTION

Embodiments of the present disclosure are described hereinafter with reference to the drawings. The drawings illustrate some embodiments of the present disclosure, but the present disclosure may be implemented in various manners. These embodiments are provided for ease of understanding of the present disclosure. The drawings and embodiments of the present disclosure are illustrative.

Steps described in method embodiments of the present disclosure may be performed in sequence and/or in parallel. Additionally, the method embodiments may include additional steps and/or omit some of the illustrated steps. The scope of the present disclosure is not limited in this respect.

The term “include” and variations thereof used herein refer to “including, but not limited to”. The term “based on” refers to “at least partially based on”. The term “an embodiment” refers to “at least one embodiment”. The term “another embodiment” refers to “at least one other embodiment”. The term “some embodiments” refers to “at least some embodiments”. Definitions of other terms are given in the description hereinafter.

Concepts such as “first” and “second” in the present disclosure are used to distinguish between apparatuses, between modules or between units and are not intended to limit the order or mutual dependence of the functions performed by these apparatuses, modules or units.

“One” and “multiple” mentioned in the present disclosure are not limiting but illustrative. It is to be understood by those skilled in the art that “one” and “multiple” are construed as “one or more” unless otherwise specified in the context.

The names of messages or information exchanged between apparatuses in embodiments of the present disclosure are illustrative and not to limit the scope of the messages or information.

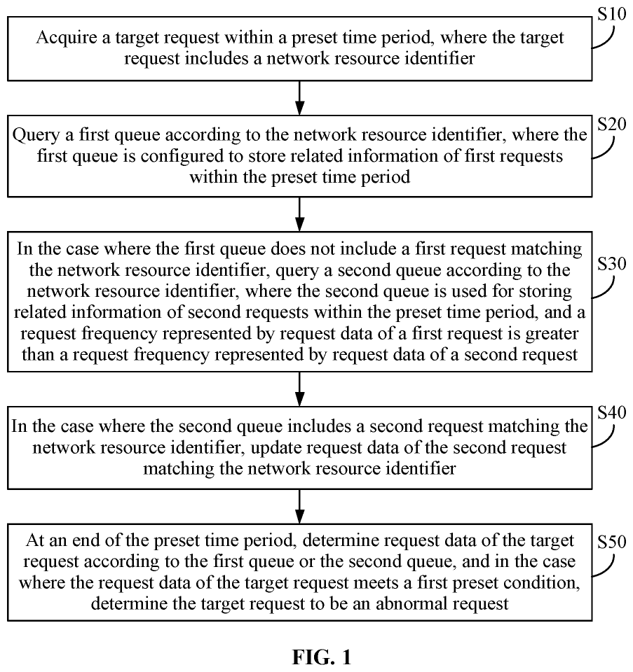

FIG. 1 is a flowchart of an abnormal request processing method according to an embodiment of the present disclosure. This embodiment is applicable to the case where an abnormal request of a networking application in a client is determined and processed. The method may be performed by an abnormal request processing apparatus. The apparatus may be implemented by software and/or hardware and may be configured in an electronic device, such as a terminal, including, but not limited to, a smartphone, a palmtop, a tablet computer, a wearable device with a display, a desktop computer, a laptop, an all-in-one computer and a smart home device. Alternatively, this embodiment is applicable to the case where an abnormal request of a networking application in a server end is determined and processed. The method may be performed by an abnormal request processing apparatus. The apparatus may be implemented by software and/or hardware and may be configured in an electronic device, such as the server.

The method is described below with the terminal as an execution body. As shown in FIG. 1, the method may include the steps described below.

In S10, a target request is acquired within a preset time period, where the target request includes a network resource identifier.

The target request may be a webpage request or a non-webpage request. The webpage request may be a HyperText Transfer Protocol (HTTP) request. The non-webpage request may be an on-demand request or a live-stream request.

The network resource identifier may be a Uniform Resource Locator (URL). The URL includes a domain name and a path. Optionally, in the present application, only the domain name in the URL is considered, and the path in the URL is not considered. That is, in the following description, that network resource identifiers of two requests are different refers to that the network resource identifiers of the two requests include different domain names; and that network resource identifiers of two requests are the same refers to that the network resource identifiers of the two requests include the same domain names.

The target request is generated based on an operation of a user on a virtual key in a user interface or may be automatically generated by the terminal based on an application service, which is not limited in the present application. For example, after the user clicks on a virtual key in the user interface, the terminal sends a request to the server, and the request is the target request. In practice, after the user operates on the virtual key in the user interface, the terminal may generate one or more target requests.

The preset time period may be set as required, which is not limited in the present application. For example, the preset time period may be 5 minutes or 10 minutes.

In S20, a first queue is queried according to the network resource identifier, where the first queue is configured to store related information of first requests within the preset time period.

The related information of the first request includes, but is not limited to, a network resource identifier of the first request and request data of the first request. Optionally, the related information of the first request may further include a time at which the first request occurs for the last time. The request data represents a request frequency. The request frequency is the number of times the first request occurs from a starting moment of the preset time period to a current moment.

In the first queue, any two first requests have different network resource identifiers.

In S30, in the case where the first queue does not include a first request matching the network resource identifier, a second queue is queried according to the network resource identifier, where the second queue is configured to store related information of second requests within the preset time period, and the request frequency represented by the request data of a first request is greater than a request frequency represented by request data of a second request.

That “the first queue does not include the first request matching the network resource identifier” refers to that the network resource identifier of the target request is compared with network resource identifiers of multiple first requests in the first queue in sequence and then it is found that the network resource identifiers of all the first requests in the first queue are different from the network resource identifier of the target request.

The related information of the second request includes, but is not limited to, a network resource identifier of the second request and the request data of the second request. Optionally, the related information of the second request may further include a time at which the second request occurs for the last time. The request data represents the request frequency. The request frequency is the number of times the second request occurs (that is, is initiated) from the starting moment of the preset time period to the current moment.

In the second queue, any two second requests have different network resource identifiers. The network resource identifier of any second request in the second queue is different from the network resource identifier of any first request in the first queue.

In S40, in the case where the second queue includes a second request matching the network resource identifier, request data of the second request matching the network resource identifier is updated.

The network resource identifier of the target request is compared with network resource identifiers of multiple second requests in the second queue in sequence until whether the second queue includes the second request matching the network resource identifier of the target request can be determined. If there is one second request with the same network resource identifier as the network resource identifier of the target request (that is, the one second request matches the network resource identifier), the one second request is considered to be the same as the target request; and the request data of the one second request is updated.

Optionally, if the related information of the second request further includes the time at which the second request occurs for the last time and there is one second request with the same network resource identifier as the network resource identifier of the target request (that is, the one second request matches the network resource identifier), updating the request data of the second request further includes: modifying the time at which the second request occurs for the last time to a time at which the target request occurs.

In S50, at an end of the preset time period, request data of the target request is determined according to the first queue or the second queue, and in the case where the request data of the target request meets a first preset condition, the target request is determined to be an abnormal request.

Optionally, request data of a request corresponding to the network resource identifier of the target request in the first queue or the second queue is directly used as the request data of the target request. Alternatively, request data of a request corresponding to the network resource identifier of the target request in the first queue or the second queue is calculated based on a preset formula so that the request data of the target request is obtained. Alternatively, request data of a request corresponding to the network resource identifier of the target request in the first queue or the second queue is analyzed, processed and subjected to statistics so that the request data of the target request is obtained.

Optionally, a first threshold for determining whether a request is the abnormal request may be set. In this case, the first preset condition is that the request data of the target request is greater than or equal to the first threshold.

An important reason for abnormal traffic consumption is a defect of an application, causing the same request to be initiated multiple times (that is, a high-frequency request occurs). For example, after the terminal sends a request to the server, the server does not respond and the terminal makes polls and periodically sends requests until the server responds. Alternatively, after the terminal sends a request to the server, a response of the server cannot satisfy a requirement of the terminal and the terminal makes polls and periodically sends requests until the response of the server satisfies the requirement of the terminal. Therefore, the abnormal request is often the high-frequency request, and the occurrence of the abnormal request often means the defect of the application.

The preceding technical scheme can be used for screening high-frequency requests and determining which high-frequency requests are abnormal requests so that developers are helped to locate reasons based on the abnormal requests, thereby eliminating faults and reducing the traffic consumption of the terminal.

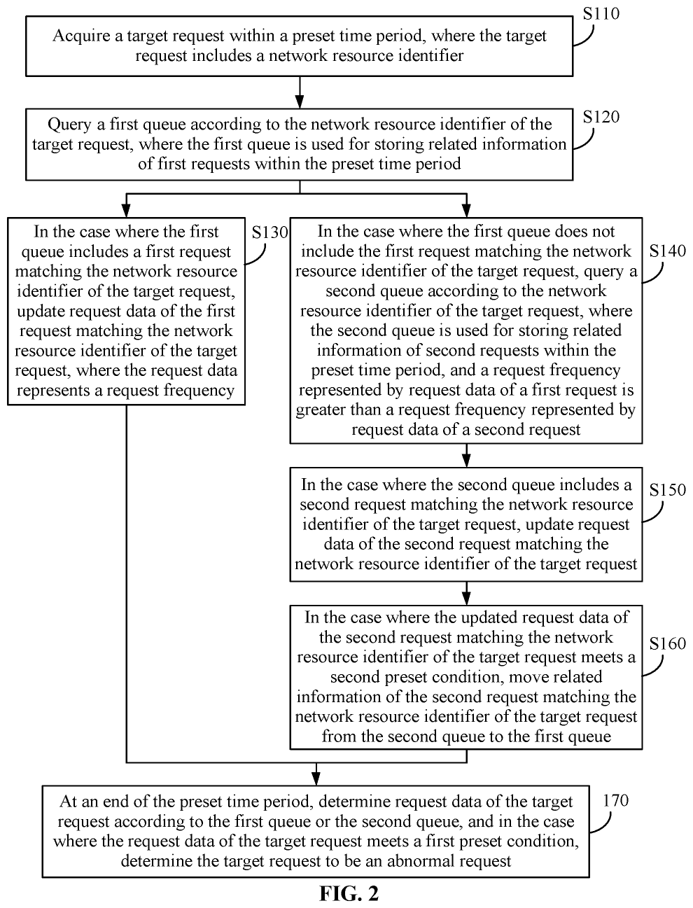

FIG. 2 is a flowchart of another abnormal request processing method according to an embodiment of the present disclosure. The example shown in FIG. 2 illustrates the example shown in FIG. 1. Referring to FIG. 2, the method includes the steps described below.

In S110, a target request is acquired within a preset time period, where the target request includes a network resource identifier.

The target request may be a webpage request or a non-webpage request. The webpage request may be a Hyper Text Transfer Protocol (HTTP) request. The non-webpage request may be an on-demand request or a live-stream request.

The network resource identifier may be a URL. The URL includes a domain name and a path. Optionally, in the present application, only the domain name in the URL is considered, and the path in the URL is not considered. That is, in the following description, that network resource identifiers of two requests are different refers to that the network resource identifiers of the two requests include different domain names; and that network resource identifiers of two requests are the same refers to that the network resource identifiers of the two requests include the same domain names.

The target request is generated based on an operation of a user on a virtual key in a user interface or may be automatically generated by a terminal based on an application service, which is not limited in the present application. For example, after the user clicks on a virtual key in the user interface, the terminal sends a request to a server, and the request is the target request. In practice, after the user operates on the virtual key in the user interface, the terminal may generate one or more target requests.

The preset time period may be set as required, which is not limited in the present application. For example, the preset time period may be 5 minutes or 10 minutes.

In S120, a first queue is queried according to the network resource identifier of the target request, where the first queue is configured to store related information of first requests within the preset time period.

The related information of the first request includes, but is not limited to, a network resource identifier of the first request and request data of the first request. Optionally, the related information of the first request may further include a time at which the first request occurs for the last time. The request data represents a request frequency. The request frequency is the number of times the first request occurs from a starting moment of the preset time period to a current moment.

In the first queue, any two first requests have different network resource identifiers.

In S130, in the case where the first queue includes a first request matching the network resource identifier of the target request, request data of the first request matching the network resource identifier of the target request is updated, where the request data represents a request frequency.

The network resource identifier of the target request is compared with network resource identifiers of multiple first requests in the first queue in sequence until whether the first queue includes the first request matching the network resource identifier of the target request can be determined. If there is one first request with the same network resource identifier as the network resource identifier of the target request (that is, the one first request matches the network resource identifier), the one first request is considered to be the same as the target request; and the request data of the one first request is updated.

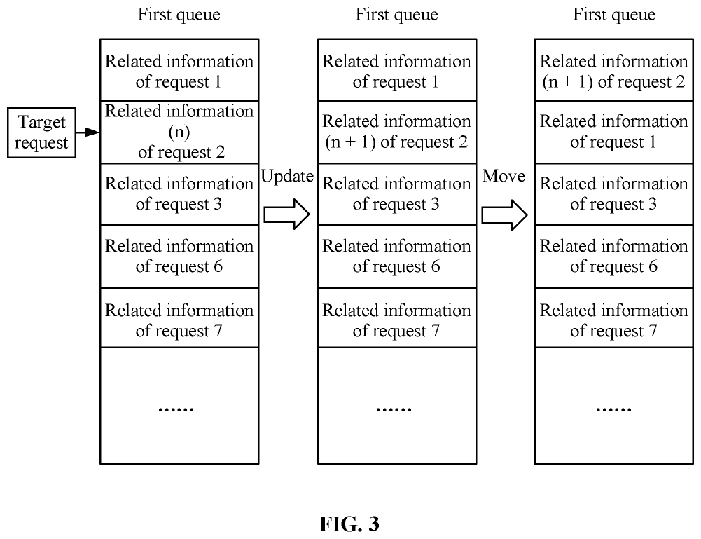

FIG. 3 is a schematic diagram of the principle of a method for implementing S130 according to an embodiment of the present disclosure. For example, referring to FIG. 3, the first queue includes related information of five first requests, which is related information of request 1, related information of request 2, related information of request 3, related information of request 6 and related information of request 7, separately. If it is found through comparison that a network resource identifier of request 2 is the same as the network resource identifier of the target request, request 2 is considered to be the same as the target request, and request data of request 2 (that is, a request frequency of request 2) is updated. An update method may be increasing the request data of request 2 by 1. For example, the request data of request 2 to be updated is n, and the updated request data of request 2 is n+1.

Optionally, if the related information of the first request further includes the time at which the first request occurs for the last time and there is one first request with the same network resource identifier as the network resource identifier of the target request (that is, the one first request matches the network resource identifier), updating the request data of the first request further includes: modifying the time at which the first request occurs for the last time to a time at which the target request occurs.

This step is essentially to merge the target request with the first request matching the network resource identifier of the target request in the first queue.

Optionally, after this step is performed, the method further includes that: related information of the first request matching the network resource identifier of the target request is moved to a head of the first queue. For example, still referring to FIG. 3, the first request matching the network resource identifier of the target request is request 2. Before being moved, related information of request 2 is located at a second position of the first queue. After being moved, the related information of request 2 is located at the head (that is, the first position) of the first queue.

In practice, the case where the same request is continually initiated multiple times within a relatively short time often occurs. For this case, if a request is continually initiated twice, the request is initiated for the s-th time and initiated for the (s+1)-th time, separately. When the request is initiated for the s-th time, this step is performed so that it is determined that the request initiated for the s-th time corresponds to a first request A in the first queue and related information of the first request A is moved to the head of the first queue. Next, when the request is initiated for the (s+1)-th time, to perform this step, a network resource identifier of the request initiated for the (s+1)-th time needs to be compared with the network resource identifiers of the multiple first requests in the first queue in sequence. Since the request initiated for the (s+1)-th time is the same as the request initiated for the s-th time, the request initiated for the (s+1)-th time also corresponds to the first request A. At this time, the first request A has already been at the head of the first queue. In this manner, that “the first queue includes the first request matching the network resource identifier of the target request” can be obtained simply by one match. With this configuration, the time required for the subsequent comparison of the network resource identifier of the same target request with the network resource identifiers of the multiple first requests in the first queue can be reduced, and a calculation rate can be increased.

In S140, in the case where the first queue does not include the first request matching the network resource identifier of the target request, a second queue is queried according to the network resource identifier, where the second queue is configured to store related information of second requests within the preset time period, and the request frequency represented by the request data of a first request is greater than a request frequency represented by request data of a second request.

That “the first queue does not include the first request matching the network resource identifier of the target request” refers to that the network resource identifier of the target request is compared with the network resource identifiers of the multiple first requests in the first queue in sequence and then it is found that the network resource identifiers of all the first requests in the first queue are different from the network resource identifier of the target request.

The related information of the second request includes, but is not limited to, a network resource identifier of the second request and the request data of the second request. Optionally, the related information of the second request may further include a time at which the second request occurs for the last time. The request data represents the request frequency. The request frequency is the number of times the second request occurs (that is, is initiated) from the starting moment of the preset time period to the current moment.

In the second queue, any two second requests have different network resource identifiers. The network resource identifier of any second request in the second queue is different from the network resource identifier of any first request in the first queue.

In S150, in the case where the second queue includes a second request matching the network resource identifier of the target request, request data of the second request matching the network resource identifier of the target request is updated.

The network resource identifier of the target request is compared with network resource identifiers of multiple second requests in the second queue in sequence until whether the second queue includes the second request matching the network resource identifier of the target request can be determined. If there is one second request with the same network resource identifier as the network resource identifier of the target request (that is, the one second request matches the network resource identifier), the one second request is considered to be the same as the target request; and the request data of the one second request is updated.

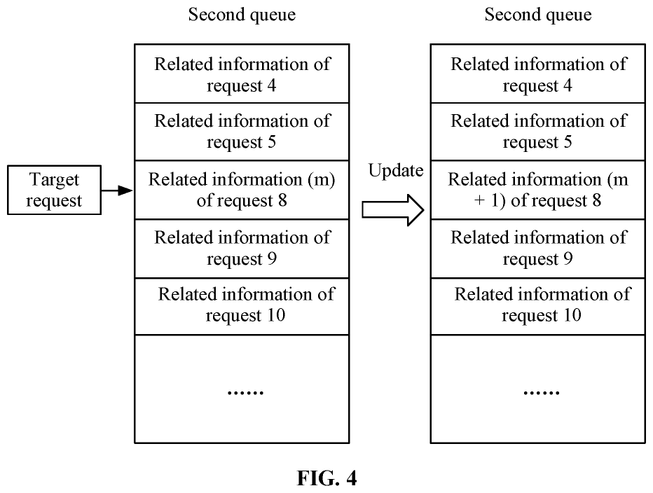

FIG. 4 is a schematic diagram of the principle of a method for implementing S150 according to an embodiment of the present disclosure. For example, referring to FIG. 4, the second queue includes related information of five second requests, which is related information of request 4, related information of request 5, related information of request 8, related information of request 9 and related information of request 10, separately. If it is found through comparison that a network resource identifier of request 8 is the same as the network resource identifier of the target request, request 8 is considered to be the same as the target request, and request data of request 8 (that is, a request frequency of request 8) is updated. An update method may be increasing the request data of request 8 by 1. For example, the request data of request 8 to be updated is m, and the updated request data of request 8 is m+1.

Optionally, if the related information of the second request further includes the time at which the second request occurs for the last time and there is one second request with the same network resource identifier as the network resource identifier of the target request (that is, the one second request matches the network resource identifier), updating the request data of the second request further includes: modifying the time at which the second request occurs for the last time to the time at which the target request occurs.

This step is essentially to merge the target request with the second request matching the network resource identifier of the target request in the second queue.

In the case where the second queue does not include the second request matching the network resource identifier of the target request, related information of the target request is stored into the second queue. In this case, that “the related information of the target request is stored into the second queue” should be understood as that related information of a new second request is generated based on the related information of the target request, and the related information of the newly generated second request is stored into the second queue.

In the case where the length of the second queue meets a fifth preset condition, related information of a second request at a tail of the second queue is deleted. For example, a fifth threshold is set, and the fifth preset condition is that the length of the second queue is greater than or equal to the fifth threshold. The fifth threshold is to limit the length of the second queue so that the number of requests that can be stored in the second queue is limited. “In the case where the length of the second queue meets a third preset condition, the related information of the second request at the tail of the second queue is deleted”, which is essentially to eliminate the second request at the tail of the second queue, so that the number of requests in the second queue is always within a reasonable range. In this manner, a load of a system in the terminal can be reduced, and the system keeps running efficiently.

In S160, in the case where the updated request data of the second request matching the network resource identifier of the target request meets a second preset condition, related information of the second request matching the network resource identifier of the target request is moved from the second queue to the first queue.

The request frequency represented by the request data of the first request is greater than the request frequency represented by the request data of the second request, the first queue is configured to store the related information of the first requests within the preset time period, and the second queue is configured to store the related information of the second requests within the preset time period. Therefore, the first queue is essentially a queue for storing related information of a high-frequency request, and the second queue is a queue for storing related information of a lower high-frequency request.

The second preset condition refers to a condition that can be used for determining whether a request belongs to the high-frequency request or the lower high-frequency request. Optionally, in practice, a second threshold may be set for distinguishing whether the request belongs to the high-frequency request or the lower high-frequency request. If request data of a request is greater than the second threshold, the request is determined to be the high-frequency request, and related data of the request needs to be stored in the first queue. If request data of a request is less than or equal to the second threshold, the request is determined to be the lower high-frequency request, and related data of the request needs to be stored in the second queue. In this case, the second preset condition is that the updated request data of the second request matching the network resource identifier of the target request is greater than the second threshold.

Accordingly, this step may be replaced with that in the case where the updated request data of the second request matching the network resource identifier of the target request is greater than the second threshold, the related information of the second request matching the network resource identifier is moved from the second queue to the first queue.

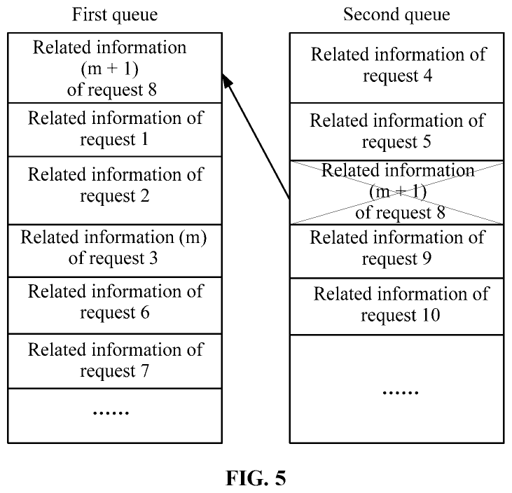

FIG. 5 is a schematic diagram of the principle of a method for implementing S160 according to an embodiment of the present disclosure. For example, referring to FIGS. 4 and 5, assuming that the second threshold is K/2, after the target request is merged with request 8 in the second queue, the request data of request 8 is updated to m+1. A relationship between m+1 and K/2 in size is determined. If m+1>K/2, related data of request 8 is moved from the second queue to the first queue.

After the target request is merged with the second request matching the network resource identifier of the target request in the second queue, whether the merged second request is promoted from the lower high-frequency request to the high-frequency request is determined. If the merged second request is promoted from the lower high-frequency request to the high-frequency request, the related information of the second request is moved from the second queue to the first queue.

That “the related information of the second request matching the network resource identifier of the target request is moved from the second queue to the first queue” in this step may be replaced with that the related information of the second request matching the network resource identifier is moved from the second queue to the head of the first queue, and the related information of the second request matching the network resource identifier is deleted from the second queue.

Similarly, “the related information of the second request matching the network resource identifier of the target request is moved from the second queue to the head of the first queue” so that the time required for the subsequent comparison of the network resource identifier of the same target request with the network resource identifiers of the multiple first requests in the first queue can be reduced, and the calculation rate can be increased.

“The related information of the second request matching the network resource identifier is deleted from the second queue” so that the two queues do not include the same requests, which is conducive to ensuring that the two queues are clearly defined all the time (in the first queue, the request data of any first request is greater than the second threshold; and in the second queue, the request data of any second request is less than or equal to the second threshold), preventing subsequent operations from being confused and avoiding a poor phenomenon of a defect of a program.

After the related information of the second request matching the network resource identifier of the target request is moved from the second queue to the first queue, the method further includes that in the case where the length of the first queue meets a third preset condition, related information of a first request meeting a fourth preset condition in the first queue is deleted. For example, a third threshold is set, and the third preset condition is that the length of the first queue is greater than or equal to the third threshold.

The third threshold is to limit the length of the first queue so that the number of requests that can be stored in the first queue is limited. Optionally, in practice, the third threshold for limiting the length of the first queue may be the same as or different from the above-mentioned fifth threshold for limiting the length of the second queue, which is not limited in the present application.

The fourth preset condition is to screen a first request to be eliminated in the first queue. The fourth preset condition is set by multiple methods. For example, a latest request time of the first request meeting the fourth preset condition is earlier than a preset time point, and request data of the first request meeting the fourth preset condition is less than a fourth threshold.

The preset time point should be any time point between the starting moment of the preset time period and the current moment. A value of the preset time point is not limited in the present application. Optionally, the preset time point may be set to be a middle time point between the current moment and the starting moment of the preset time period. For example, if the starting moment of the preset time period is T and the current moment is t, the preset time point is T+(t−T)/2. The fourth threshold is to screen a first request with relatively small request data in the first queue.

“In the case where the length of the first queue meets the third preset condition, the related information of the first request meeting the fourth preset condition in the first queue is deleted”, which is essentially to eliminate a first request having relatively small request data and occurring at a relatively early moment in the first queue, so that the number of requests in the first queue is always within a reasonable range. In this manner, the load of the system in the terminal can be reduced, and the system keeps running efficiently.

After the request data of the second request matching the network resource identifier of the target request is updated, in the case where the updated request data of the second request matching the network resource identifier of the target request does not meet the second preset condition, the related information of the second request matching the network resource identifier of the target request is moved to a head of the second queue.

After the target request is merged with the second request matching the network resource identifier of the target request in the second queue, if it is determined that the merged second request still belongs to the lower high-frequency request, the related information of the second request still needs to be stored in the second queue.

Similarly, “the related information of the second request matching the network resource identifier of the target request is moved to the head of the second queue” so that the time required for the subsequent comparison of the network resource identifier of the same target request with the network resource identifiers of the multiple second requests in the second queue can be reduced, and the calculation rate can be increased.

In S170, at an end of the preset time period, request data of the target request is determined according to the first queue or the second queue, and in the case where the request data of the target request meets a first preset condition, the target request is determined to be an abnormal request.

That “at the end of the preset time period, the request data of the target request is determined according to the first queue or the second queue” includes that at the end of the preset time period, in the case where the network resource identifier of the target request is in the first queue, the request data of the target request is determined according to request data of a first request corresponding to the network resource identifier of the target request in the first queue. At the end of the preset time period, in the case where the network resource identifier of the target request is in the second queue, the request data of the target request is determined according to request data of a second request corresponding to the network resource identifier of the target request in the second queue.

That “the network resource identifier of the target request is in the first queue” corresponds to two cases. In case one, according to S130, in the case where the first queue includes the first request matching the network resource identifier of the target request, the target request is merged with the first request matching the network resource identifier of the target request in the first queue. In this case, related information of the target request is stored in the first queue.

In case two, according to S140 to S160, in the case where the second queue includes the second request matching the network resource identifier of the target request, the target request is merged with the second request matching the network resource identifier of the target request in the second queue. Then, the related information of the second request is moved from the second queue to the first queue. In this case, related information of the target request is stored in the first queue.

That “the network resource identifier of the target request is in the second queue” corresponds to one case. According to S140 to S160, in the case where the second queue includes the second request matching the network resource identifier of the target request, the target request is merged with the second request matching the network resource identifier of the target request in the second queue. Then, the related information of the second request is not moved from the second queue to the first queue. In this case, the related information of the target request is stored in the second queue.

That “the request data of the target request is determined according to the request data of the first request corresponding to the network resource identifier of the target request in the first queue” includes that the request data of the first request corresponding to the network resource identifier of the target request in the first queue is directly used as the request data of the target request. Alternatively, the request data of the first request corresponding to the network resource identifier of the target request in the first queue is calculated based on a preset formula so that the request data of the target request is obtained. Alternatively, the request data of the first request corresponding to the network resource identifier of the target request in the first queue is analyzed, processed and subjected to statistics so that the request data of the target request is obtained.

Similarly, that “the request data of the target request is determined according to the request data of the second request corresponding to the network resource identifier of the target request in the second queue” includes that the request data of the second request corresponding to the network resource identifier of the target request in the second queue is directly used as the request data of the target request. Alternatively, the request data of the second request corresponding to the network resource identifier of the target request in the first queue is calculated based on a preset formula so that the request data of the target request is obtained. Alternatively, the request data of the second request corresponding to the network resource identifier of the target request in the second queue is analyzed, processed and subjected to statistics so that the request data of the target request is obtained.

Optionally, a first threshold for determining whether a request is the abnormal request may be set. In this case, the first preset condition is that the request data of the target request is greater than or equal to the first threshold.

An important reason for abnormal traffic consumption is a defect of an application, causing the same request to be initiated multiple times (that is, the high-frequency request occurs). For example, after the terminal sends a request to the server, the server does not respond and the terminal makes polls and periodically sends requests until the server responds. Alternatively, after the terminal sends a request to the server, a response of the server cannot satisfy a requirement of the terminal and the terminal makes polls and periodically sends requests until the response of the server satisfies the requirement of the terminal. Therefore, the abnormal request is often the high-frequency request, and the occurrence of the abnormal request often means the defect of the application.

The preceding technical scheme can be used for screening high-frequency requests and determining which high-frequency requests are abnormal requests so that developers are helped to locate reasons based on the abnormal requests, thereby eliminating faults and reducing the traffic consumption of the terminal.

Based on the preceding technical scheme, optionally, that in the case where the request data of the target request meets the first preset condition, the target request is determined to be the abnormal request in S170 may be replaced with that at the end of the preset time period, in the case where the network resource identifier of the target request is in the first queue and the request data of the target request meets the first preset condition, the target request is determined to be the abnormal request. This is because the first queue is essentially a queue for storing the related information of the high-frequency request, and the second queue is a queue for storing the related information of the lower high-frequency request. Since the abnormal request is often the high-frequency request, when the abnormal request is determined, the first queue is preferentially considered to determine the abnormal request so that the time required for screening the abnormal requests can be fully reduced, and user experience can be improved.

Based on the preceding technical scheme, it is set that the target request includes a service identifier. After S170, the method further includes that a reason for abnormal traffic consumption is determined according to the service identifier included in the abnormal request. If the target request does not include the service identifier, when the reason for the abnormal traffic consumption is determined subsequently, the target request needs to be mapped to a service, so as to determine which services the target request is used for completing. The whole mapping process is complex, and a relatively high requirement is put on the system of the terminal. It is set that the target request includes the service identifier so that which services the target request is used for completing can be determined without mapping the target request to the service, which puts a relatively low requirement on the system of the terminal.

That “the reason for the abnormal traffic consumption is determined according to the service identifier included in the abnormal request” may be performed manually or performed by a computer. For example, if this step is performed manually, the terminal sends the abnormal request including the service identifier to a remote server, and a developer acquires the abnormal request including the service identifier through the remote server and checks codes of a corresponding service according to the service identifier, thereby analyzing the reason for the abnormal traffic consumption. If this step is performed by the computer, optionally, the computer determines codes of a service corresponding to the service identifier according to the service identifier included in the abnormal request and automatically checks the codes to determine the reason for the abnormal traffic consumption.

For example, the abnormal request is screened by the preceding method, and it is found that a request is initiated tens of times per minute. Codes of a service corresponding to the request are analyzed and it is found that the codes have a buffer logic error. After the terminal acquires required data from the server, the terminal should no longer send the request to the server. However, the codes of the service lack a code capable of causing the terminal to no longer send the request to the server after the terminal acquires the required data from the server. Thus, the reason for the abnormal traffic consumption is determined. Subsequently, the codes of the service may be modified, so as to reduce the number of times the request is initiated per minute and reduce a traffic loss of the user.

That the reason for the abnormal traffic consumption is determined according to the service identifier included in the abnormal request includes that in the case where total traffic consumption of the terminal within the preset time period meets a sixth preset condition, the reason for the abnormal traffic consumption is determined according to the service identifier included in the abnormal request. For example, a sixth threshold for determining whether an application of the terminal has abnormal traffic consumption is set. In this case, the sixth preset condition is that the total traffic consumption of the terminal within the preset time period is greater than or equal to the sixth threshold.

In practice, the following case may occur: although a high-frequency request occurs, the overall traffic consumption within the preset time period is relatively low. This case may be considered as that the application of the terminal has no abnormal traffic consumption. This configuration essentially means that in a running process of the application of the terminal, the abnormal request keeps being screened, but the abnormal request may not be reported. Only when the abnormal traffic consumption occurs, is the screened abnormal request reported, so as to locate the reason for the abnormal traffic consumption.

Before the reason for the abnormal traffic consumption is determined according to the service identifier included in the abnormal request in the case where the total traffic consumption of the terminal within the preset time period meets the sixth preset condition, the method further includes that: the total traffic consumption of the terminal within the preset time period is determined.

There are multiple manners for that “the total traffic consumption of the terminal within the preset time period is determined”, which are not limited in the present application. For example, statistics of the total traffic consumption of the terminal within the preset time period may be directly obtained by using a traffic monitoring application. Alternatively, in the process of performing the abnormal request processing method provided by the present disclosure, traffic consumed by multiple target requests acquired within the preset time period is monitored; and a sum of the traffic consumed by the multiple target requests acquired within the preset time period is calculated so that the total traffic consumption of the terminal within the preset time period is obtained.

For any target request, the terminal has certain traffic consumption when sending the target request. The server responds to the target request and sends response information to the terminal. When the terminal receives the response information corresponding to the target request, the terminal has certain traffic consumption again. Therefore, traffic consumed by any target request includes traffic consumed for sending the target request and traffic consumed for receiving the response information.

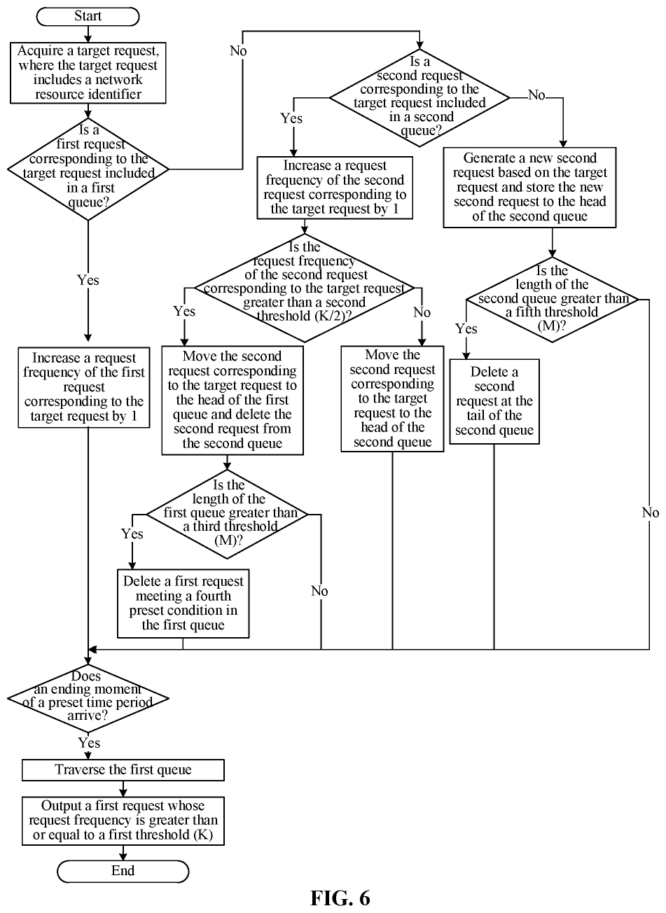

FIG. 6 is a flowchart of another abnormal request processing method according to an embodiment of the present disclosure. The example shown in FIG. 6 illustrates the example shown in FIG. 1. It is assumed that a first threshold is K, that is, when request data of a target request is greater than or equal to K, the target request is determined to be an abnormal request. A second threshold is K/2, that is, related data of a request whose request data is greater than K/2 should be stored in a first queue; and related data of a request whose request data is less than or equal to K/2 should be stored in a second queue. A third threshold and a fifth threshold are both M, that is, a maximum number of requests allowed to be stored in the first queue and a maximum number of requests allowed to be stored in the second queue are both M. A starting moment of a preset time period is T, a duration of the preset time period is 10 minutes, a current moment is t, a fourth threshold is N, where K<N<K/2, and a fourth preset condition is that a latest request time of a first request is earlier than (T+(t−T)/2) and request data of the first request is less than N. Referring to FIG. 6, the method includes the steps described below.

A step of acquiring the target request is continuously performed within the preset time period. For any target request, the processing steps below are performed until the preset time period ends.

For any target request, the processing steps below need to be performed.

When a target request is acquired, a network resource identifier (that is, a URL) in the target request is extracted, and then the first queue is queried, so as to determine whether the first queue includes a first request corresponding to the target request. That the first request corresponds to the target request refers to that a network resource identifier of a first request is the same as the network resource identifier of the target request. If the first queue includes the first request corresponding to the target request, a request frequency of the first request corresponding to the target request is increased by 1, and related information of the first request is moved to a head of the first queue.

If the first queue does not include the first request corresponding to the target request, whether the second queue includes a second request corresponding to the target request is determined. That the second request corresponds to the target request refers to that a network resource identifier of a second request is the same as the network resource identifier of the target request. If the second queue includes the second request corresponding to the target request, a request frequency of the second request corresponding to the target request is increased by 1. After the request frequency of the second request corresponding to the target request is increased by 1, whether the request frequency of the second request corresponding to the target request is greater than K/2 is determined.

After the request frequency of the second request corresponding to the target request is increased by 1, if the request frequency of the second request corresponding to the target request is greater than K/2, related information of the second request is moved to the head of the first queue and removed from the second queue. After the request frequency of the second request corresponding to the target request is increased by 1, if the request frequency of the second request corresponding to the target request is less than or equal to K/2, the related information of the second request is moved to a head of the second queue.

After “the related information of the second request is moved to the head of the first queue and removed from the second queue”, if the length of the first queue is greater than M, a first request meeting the fourth preset condition (that is, a latest request time of the first request is earlier than (T+(t−T)/2) and request data of the first request is less than N) in the first queue is deleted.

If the second queue does not include the second request corresponding to the target request, related information of a new second request is generated based on the target request and stored to the head of the second queue. A request frequency of the newly generated second request is 1. After the newly generated second request is stored in the second queue, if the length of the second queue is greater than M, related information of a second request at a tail of the second queue is deleted.

After the preset time period ends, the first queue is traversed, so as to determine whether a first request whose request frequency is greater than or equal to K exists. If so, the first request is outputted. The outputted first request is the abnormal request.

The preceding technical scheme can be used for screening high-frequency requests and determining which high-frequency requests are abnormal requests so that developers are helped to locate reasons based on the abnormal requests, thereby eliminating faults and reducing the traffic consumption of a terminal.

Another important reason for abnormal traffic consumption is too large traffic consumption of a single request. For example, a user clicks to play a very large video stream, and too much traffic is consumed. For this case, traffic consumed by multiple target requests needs to be tracked.

In the process of performing the abnormal request processing method provided by the present disclosure, traffic separately consumed by all the acquired target requests is monitored; and whether traffic consumed by one target request is greater than a seventh threshold is determined. If traffic consumed by one target request is greater than the seventh threshold, the target request is determined to be the abnormal request. The target request includes a service identifier. After the target request is determined to be the abnormal request, the method further includes that a reason for abnormal traffic consumption is determined according to the service identifier included in the abnormal request.

Alternatively, in the process of performing the abnormal request processing method provided by the present disclosure, traffic separately consumed by all the target requests acquired within the preset time period is monitored; and at an end of the preset time period, whether traffic consumed by each of one or more requests of requests in the second queue or among all first requests meeting the fourth preset condition and deleted from the first queue is greater than the seventh threshold is determined. If traffic consumed by a request is greater than the seventh threshold, the request is determined to be the abnormal request. This configuration can reduce a screening range and quickly screen the single request having too large traffic consumption. The second request includes the service identifier. After the second request is determined to be the abnormal request, the method further includes that a reason for abnormal traffic consumption is determined according to the service identifier included in the second request.

The seventh threshold is used for determining whether a single request has too large traffic consumption. Optionally, the seventh threshold may be the same as or different from the preceding sixth threshold, which is not limited in the present application.

For example, if traffic consumption of a request is up to 500 M, the traffic consumption complies with a service scenario logic, and codes do not need to be modified in an actual service scenario where the user downloads an Android application package (Android APK). For another example, an image downloaded through a request reaches 10 M. However, in an actual service scenario, only a thumbnail needs to be downloaded. After checking, it is found that codes at an application end are incorrect in that a correct image size parameter is not carried. The codes are modified so that traffic consumed by the request can be reduced to tens of KBs, thereby reducing a traffic loss of the user.

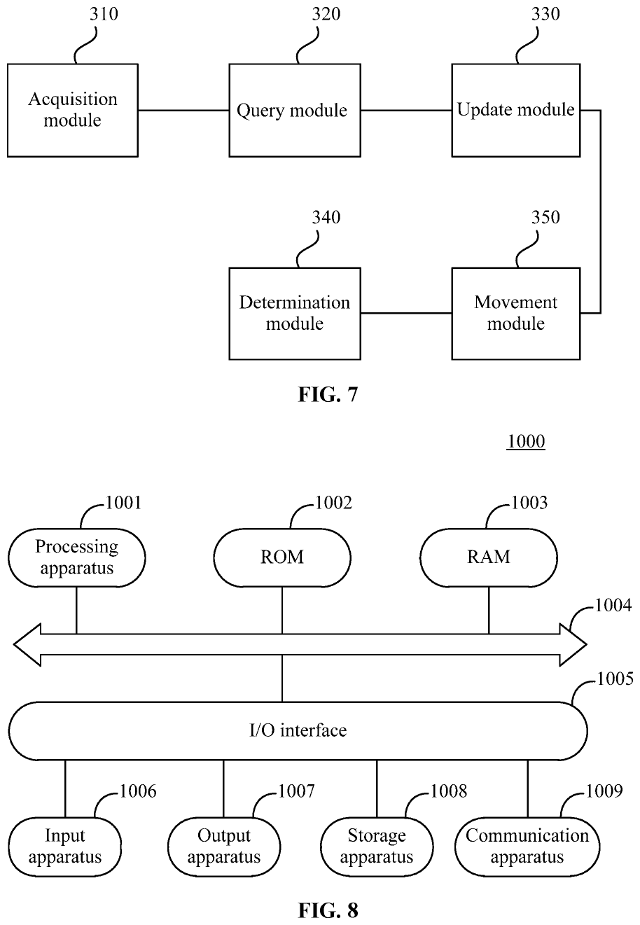

FIG. 7 is a structure diagram of an abnormal request processing apparatus according to an embodiment of the present disclosure. The abnormal request processing apparatus provided in the embodiment of the present disclosure may be configured in a client or a server. The abnormal request processing apparatus includes an acquisition module 310, a query module 320, an update module 330 and a determination module 340. The acquisition module 310 is configured to acquire a target request within a preset time period, where the target request includes a network resource identifier. The query module 320 is configured to query a first queue according to the network resource identifier, where the first queue is configured to store related information of first requests within the preset time period. The query module 320 is further configured to, in the case where the first queue does not include a first request matching the network resource identifier, query a second queue according to the network resource identifier, where the second queue is configured to store related information of second requests within the preset time period, and a request frequency represented by request data of a first request is greater than a request frequency represented by request data of a second request. The update module 330 is configured to, in the case where the second queue includes a second request matching the network resource identifier, update request data of the second request matching the network resource identifier. The determination module 340 is configured to, at an end of the preset time period, determine request data of the target request according to the first queue or the second queue, and in the case where the request data of the target request meets a first preset condition, determine the target request to be an abnormal request.

The update module 330 is further configured to, in the case where the first queue includes the first request matching the network resource identifier, update request data of the first request matching the network resource identifier, where the request data represents a request frequency. The abnormal request processing apparatus further includes a movement module 350. The movement module 350 is configured to, in the case where the updated request data of the second request matching the network resource identifier meets a second preset condition, move related information of the second request matching the network resource identifier from the second queue to the first queue.

The determination module 340 is configured to, at the end of the preset time period, in the case where the network resource identifier is in the first queue, determine the request data of the target request according to request data of a first request corresponding to the network resource identifier in the first queue; or at the end of the preset time period, in the case where the network resource identifier is in the second queue, determine the request data of the target request according to request data of a second request corresponding to the network resource identifier in the second queue.

The movement module 350 is configured to, after the request data of the first request matching the network resource identifier is updated, move related information of the first request matching the network resource identifier to a head of the first queue.

The movement module 350 is configured to move the related information of the second request matching the network resource identifier from the second queue to the head of the first queue. The apparatus further includes a deletion module. The deletion module is configured to delete the related information of the second request matching the network resource identifier from the second queue.

The movement module 350 is configured to, in the case where the length of the first queue meets a third preset condition after the related information of the second request matching the network resource identifier is moved from the second queue to the first queue, delete related information of a first request meeting a fourth preset condition in the first queue.

The movement module 350 is configured to, in the case where the updated request data of the second request matching the network resource identifier does not meet the second preset condition after the request data of the second request matching the network resource identifier is updated, move the related information of the second request matching the network resource identifier to a head of the second queue.

The update module 330 is configured to, in the case where the second queue does not include the second request matching the network resource identifier, store related information of the target request into the second queue. The deletion module is configured to, in the case where the length of the second queue meets a fifth preset condition, delete related information of a second request at a tail of the second queue.

The determination module 340 is configured to, at the end of the preset time period, in the case where the network resource identifier is in the first queue and the request data of the target request meets the first preset condition, determine the target request to be the abnormal request.

The target request includes a service identifier.

The determination module 340 is configured to determine a reason for abnormal traffic consumption according to the service identifier included in the abnormal request.

The determination module 340 is configured to, in the case where total traffic consumption of the terminal within the preset time period meets a sixth preset condition, determine the reason for the abnormal traffic consumption according to the service identifier included in the abnormal request.

The abnormal request processing apparatus provided in the embodiment of the present disclosure may perform steps performed by the client or the server in the abnormal request processing method provided in a method embodiment of the present disclosure, and the performed steps and effects are not repeated here.

FIG. 8 is a structure diagram of an electronic device according to an embodiment of the present disclosure. FIG. 8 shows a structure diagram of an electronic device 1000 for implementing an embodiment of the present disclosure. The electronic device 1000 in the embodiment of the present disclosure may include, but is not limited to, a mobile terminal such as a mobile phone, a laptop, a digital broadcast receiver, a personal digital assistant (PDA), a portable Android device (PAD), a portable media player (PMP), an in-vehicle terminal (such as an in-vehicle navigation terminal) and a wearable electronic device and a stationary terminal such as a digital television (TV), a desktop computer and a smart home device. The electronic device 1000 shown in FIG. 8 is merely an example and is not intended to limit the function and use scope of embodiments of the present disclosure.

As shown in FIG. 8, the electronic device 1000 may include a processing apparatus (such as a central processing unit or a graphics processing unit) 1001. The processing apparatus 1001 can perform various appropriate actions and processing according to a program stored in a read-only memory (ROM) 1002 or a program loaded into a random-access memory (RAM) 1003 from a storage apparatus 1008 to implement the performance problem location method in an embodiment of the present disclosure. Various programs and information required for the operation of the electronic device 1000 may also be stored in the RAM 1003. The processing apparatus 1001, the ROM 1002 and the RAM 1003 are connected to each other through a bus 1004. An input/output (I/O) interface 1005 is also connected to the bus 1004.

Generally, the following apparatuses may be connected to the I/O interface 1005: an input apparatus 1006 such as a touch screen, a touchpad, a keyboard, a mouse, a camera, a microphone, an accelerometer and a gyroscope; an output apparatus 1007 such as a liquid crystal display (LCD), a speaker and a vibrator; the storage apparatus 1008 such as a magnetic tape and a hard disk; and a communication apparatus 1009. The communication apparatus 1009 may allow the electronic device 1000 to perform wireless or wired communication with other devices to exchange information. Although FIG. 8 shows the electronic device 1000 having various apparatuses, it is not required to implement or include all the apparatuses shown. Alternatively, more or fewer apparatuses may be implemented or included.

According to an embodiment of the present disclosure, the process described above with reference to flowcharts may be implemented as a computer software program. For example, a computer program product is included in the embodiment of the present disclosure. The computer program product includes a computer program carried on a non-transitory computer-readable medium. The computer program includes program codes for performing the methods shown in the flowcharts, so as to implement the abnormal request processing method described above. In such embodiments, the computer program may be downloaded and installed from a network through the communication apparatus 1009, installed from the storage apparatus 1008 or installed from the ROM 1002. When the computer program is executed by the processing apparatus 1001, the preceding functions defined in the methods in the embodiments of the present disclosure are performed.

The preceding computer-readable medium of the present disclosure may be a computer-readable signal medium or a computer-readable storage medium or any combination thereof. For example, the computer-readable storage medium may be, but is not limited to, an electrical, magnetic, optical, electromagnetic, infrared or semiconductor system, apparatus or device or any combination thereof. Examples of the computer-readable storage medium may include, but are not limited to, an electrical connection with one or more wires, a portable computer disk, a hard disk, a RAM, a ROM, an erasable programmable read-only memory (EPROM), a flash memory, an optical fiber, a portable compact disc read-only memory (CD-ROM), an optical storage device, a magnetic storage device or any appropriate combination thereof. In the present disclosure, the computer-readable storage medium may be any tangible medium including or storing a program that can be used by or in connection with an instruction execution system, apparatus or device. In the present disclosure, the computer-readable signal medium may include an information signal propagated on a baseband or as part of a carrier, where computer-readable program codes are carried in the information signal. The information signal propagated in this manner may be in multiple forms and includes, but is not limited to, an electromagnetic signal, an optical signal or any appropriate combination thereof. The computer-readable signal medium may also be any computer-readable medium except the computer-readable storage medium. The computer-readable signal medium may send, propagate or transmit a program used by or in connection with an instruction execution system, apparatus or device. Program codes included on the computer-readable medium may be transmitted by any appropriate medium, including, but not limited to, a wire, an optical cable, a radio frequency (RF) or any appropriate combination thereof.

In some embodiments, clients and servers can communicate using any network protocol known or developed in the future, such as an HTTP, and may be interconnected via any form or medium of digital information communication (for example, a communication network). Examples of the communication network include a local area network (LAN), a wide area network (WAN), an inter-network (for example, the Internet), a peer-to-peer network (for example, an ad hoc network) and any network known or developed in the future.

The preceding computer-readable medium may be included in the preceding electronic device or may exist alone without being assembled into the electronic device.

The preceding computer-readable medium carries one or more programs. When executed by the electronic device, the one or more programs cause the electronic device to: acquire a target request within a preset time period, where the target request includes a network resource identifier; query a first queue according to the network resource identifier, where the first queue is configured to store related information of a first request within the preset time period; in the case where the first queue does not include a first request matching the network resource identifier, query a second queue according to the network resource identifier, where the second queue is configured to store related information of a second request within the preset time period, and a request frequency represented by request data of the first request is greater than a request frequency represented by request data of the second request; in the case where the second queue includes a second request matching the network resource identifier, update request data of the second request matching the network resource identifier; and at an end of the preset time period, determine request data of the target request according to the first queue or the second queue, and in the case where the request data of the target request meets a first preset condition, determine the target request to be an abnormal request.

Optionally, when the preceding one or more programs are executed by the electronic device, the electronic device may also perform other steps in the preceding embodiments.

Computer program codes for executing operations in the present disclosure may be written in one or more programming languages or a combination thereof. The preceding programming languages include, but are not limited to, an object-oriented programming language such as Java, Smalltalk or C++ and may also include a conventional procedural programming language such as C or a similar programming language. The program codes may be executed entirely on a user computer, executed partly on a user computer, executed as a stand-alone software package, executed partly on a user computer and partly on a remote computer or executed entirely on a remote computer or a server. In the case where the remote computer is involved, the remote computer may be connected to the user computer through any type of network including a LAN or a WAN or may be connected to an external computer (for example, through the Internet provided by an Internet service provider).

Flowcharts and block diagrams among the drawings illustrate the architecture, functionality and operation of possible implementations of systems, methods and computer program products according to various embodiments of the present disclosure. In this regard, each block in the flowcharts or the block diagrams may represent a module, program segment or part of codes, where the module, program segment or part of codes includes one or more executable instructions for implementing specified logical functions. It is to be noted that in some alternative implementations, the functions marked in the blocks may occur in an order different from that marked in the drawings. For example, two successive blocks may, in practice, be executed substantially in parallel or executed in a reverse order, which depends on the functions involved. It is also to be noted that each block in the block diagrams and/or the flowcharts and a combination of blocks in the block diagrams and/or the flowcharts may be implemented by a special-purpose hardware-based system performing specified functions or operations or may be implemented by a combination of special-purpose hardware and computer instructions.

The units involved in the embodiments of the present disclosure may be implemented by software or hardware. The name of a unit is not intended to limit the unit in a certain circumstance.

The functions described above herein may be performed at least in part by one or more hardware logic components. For example, without limitation, example types of hardware logic components that can be used include a field-programmable gate array (FPGA), an application-specific integrated circuit (ASIC), an application-specific standard product (ASSP), a system-on-chip (SoC), a complex programmable logic device (CPLD) and the like.

In the context of the present disclosure, a machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device or any appropriate combination thereof. Examples of the machine-readable storage medium include an electrical connection based on one or more wires, a portable computer disk, a hard disk, a RAM, a ROM, an EPROM, a flash memory, an optical fiber, a CD-ROM, an optical storage device, a magnetic storage device or any appropriate combination thereof.

According to one or more embodiments of the present disclosure, the present disclosure provides an electronic device.

The electronic device includes one or more processors and a memory configured to store one or more programs. When executed by the one or more processors, the one or more programs cause the one or more processors to perform the abnormal request processing method according to any embodiment of the present disclosure.

According to one or more embodiments of the present disclosure, the present disclosure provides a computer-readable storage medium. The storage medium stores a computer program which, when executed by a processor, causes the processor to perform the abnormal request processing method according to any embodiment of the present disclosure.

An embodiment of the present disclosure further provides a computer program product. The computer program product includes a computer program or instruction which, when executed by a processor, causes the processor to perform the abnormal request processing method described above.

As used herein, relational terms such as “first” and “second” may be used to distinguish one entity or operation from another without necessarily requiring or implying any actual relationship or order between such entities or operations. Moreover, the term “comprising”, “including” or any other variant thereof is intended to encompass a non-exclusive inclusion so that a process, method, article or device that includes a series of elements not only includes the elements but also includes other elements that are not expressly listed or are inherent to such process, method, article or device. In the absence of more restrictions, the elements defined by the statement “including a . . . ” do not exclude the presence of additional identical elements in the process, method, article or device that includes the elements.

1. An abnormal request processing method, comprising:
acquiring a target request within a preset time period, wherein the target request comprises a network resource identifier;
querying a first queue according to the network resource identifier, wherein the first queue is configured to store related information of first requests within the preset time period;
in a case where the first queue does not comprise a first request matching the network resource identifier, querying a second queue according to the network resource identifier, wherein the second queue is configured to store related information of second requests within the preset time period, and a request frequency represented by request data of a first request of the first requests is greater than a request frequency represented by request data of a second request of the second requests;
in a case where the second queue comprises a second request matching the network resource identifier, updating request data of the second request matching the network resource identifier; and
at an end of the preset time period, determining request data of the target request according to the first queue or the second queue, and in a case where the request data of the target request meets a first preset condition, determining the target request to be an abnormal request.

2. The method of claim 1, wherein after querying the first queue according to the network resource identifier, the method further comprising:
in a case where the first queue comprises the first request matching the network resource identifier, updating request data of the first request matching the network resource identifier, wherein the request data represents a request frequency; and
wherein after updating the request data of the second request matching the network resource identifier, the method further comprises:
in a case where the updated request data of the second request matching the network resource identifier meets a second preset condition, moving related information of the second request matching the network resource identifier from the second queue to the first queue.

3. The method of claim 1, wherein at the end of the preset time period, determining the request data of the target request according to the first queue or the second queue comprises:
at the end of the preset time period, in a case where the network resource identifier is in the first queue, determining the request data of the target request according to request data of a first request corresponding to the network resource identifier in the first queue; or
at the end of the preset time period, in a case where the network resource identifier is in the second queue, determining the request data of the target request according to request data of a second request corresponding to the network resource identifier in the second queue.

4. The method of claim 2, after updating the request data of the first request matching the network resource identifier, further comprising:
moving related information of the first request matching the network resource identifier to a head of the first queue.

5. The method of claim 2, wherein moving the related information of the second request matching the network resource identifier from the second queue to the first queue comprises:
moving the related information of the second request matching the network resource identifier from the second queue to a head of the first queue, and deleting the related information of the second request matching the network resource identifier from the second queue.

6. The method of claim 2, after moving the related information of the second request matching the network resource identifier from the second queue to the first queue, further comprising:
in a case where a length of the first queue meets a third preset condition, deleting related information of a first request meeting a fourth preset condition from the first queue.

7. The method of claim 1, after updating the request data of the second request matching the network resource identifier, further comprising:
in a case where the updated request data of the second request matching the network resource identifier does not meet a second preset condition, moving related information of the second request matching the network resource identifier to a head of the second queue.

8. The method of claim 1, further comprising:
in a case where the second queue does not comprise the second request matching the network resource identifier, storing related information of the target request into the second queue; and
in a case where a length of the second queue meets a fifth preset condition, deleting related information of a second request at a tail of the second queue.

9. The method of claim 1, wherein in the case where the request data of the target request meets the first preset condition, determining the target request to be the abnormal request comprises:
at the end of the preset time period, in a case where the network resource identifier is in the first queue and the request data of the target request meets the first preset condition, determining the target request to be the abnormal request.

10. The method of claim 1, wherein the target request comprises a service identifier; and
wherein after determining the target request to be the abnormal request, the method further comprises:
determining a reason for abnormal traffic consumption according to the service identifier comprised in the abnormal request.

11. The method of claim 10, wherein determining the reason for the abnormal traffic consumption according to the service identifier comprised in the abnormal request comprises:
in a case where total traffic consumption of a terminal within the preset time period meets a sixth preset condition, determining the reason for the abnormal traffic consumption according to the service identifier comprised in the abnormal request.

12. (canceled)

13. An electronic device, comprising:
at least one processor; and
a storage apparatus configured to store at least one program;
wherein the at least one program, when executed by the at least one processor, causes the at least one processor to perform:
acquiring a target request within a preset time period, wherein the target request comprises a network resource identifier;
querying a first queue according to the network resource identifier, wherein the first queue is configured to store related information of first requests within the preset time period;
in a case where the first queue does not comprise a first request matching the network resource identifier, querying a second queue according to the network resource identifier, wherein the second queue is configured to store related information of second requests within the preset time period, and a request frequency represented by request data of a first request of the first requests is greater than a request frequency represented by request data of a second request of the second requests;
in a case where the second queue comprises a second request matching the network resource identifier, updating request data of the second request matching the network resource identifier; and
at an end of the preset time period, determining request data of the target request according to the first queue or the second queue, and in a case where the request data of the target request meets a first preset condition, determining the target request to be an abnormal request.

14. A non-transitory computer-readable storage medium, which is configured to store a computer program, wherein the computer program, when executed by a processor, implements:
acquiring a target request within a preset time period, wherein the target request comprises a network resource identifier;
querying a first queue according to the network resource identifier, wherein the first queue is configured to store related information of first requests within the preset time period;
in a case where the first queue does not comprise a first request matching the network resource identifier, querying a second queue according to the network resource identifier, wherein the second queue is configured to store related information of second requests within the preset time period, and a request frequency represented by request data of a first request of the first requests is greater than a request frequency represented by request data of a second request of the second requests;
in a case where the second queue comprises a second request matching the network resource identifier, updating request data of the second request matching the network resource identifier; and
at an end of the preset time period, determining request data of the target request according to the first queue or the second queue, and in a case where the request data of the target request meets a first preset condition, determining the target request to be an abnormal request.

15. The electronic device of claim 13, wherein the at least one program, when executed by the at least one processor, causes the at least one processor to, after performing querying the first queue according to the network resource identifier perform, further perform:
in a case where the first queue comprises the first request matching the network resource identifier, updating request data of the first request matching the network resource identifier, wherein the request data represents a request frequency; and
wherein the at least one program, when executed by the at least one processor, causes the at least one processor to, after performing updating the request data of the second request matching the network resource identifier, further perform:
in a case where the updated request data of the second request matching the network resource identifier meets a second preset condition, moving related information of the second request matching the network resource identifier from the second queue to the first queue.

16. The electronic device of claim 13, wherein the at least one program, when executed by the at least one processor, causes the at least one processor to perform at the end of the preset time period, determining the request data of the target request according to the first queue or the second queue in the following way:
at the end of the preset time period, in a case where the network resource identifier is in the first queue, determining the request data of the target request according to request data of a first request corresponding to the network resource identifier in the first queue; or
at the end of the preset time period, in a case where the network resource identifier is in the second queue, determining the request data of the target request according to request data of a second request corresponding to the network resource identifier in the second queue.

17. The electronic device of claim 15, wherein the at least one program, when executed by the at least one processor, causes the at least one processor to, after performing updating the request data of the first request matching the network resource identifier, further perform:
moving related information of the first request matching the network resource identifier to a head of the first queue.

18. The electronic device of claim 15, wherein the at least one program, when executed by the at least one processor, causes the at least one processor to perform moving the related information of the second request matching the network resource identifier from the second queue to the first queue in the following way:
moving the related information of the second request matching the network resource identifier from the second queue to a head of the first queue, and deleting the related information of the second request matching the network resource identifier from the second queue.

19. The electronic device of claim 15, wherein the at least one program, when executed by the at least one processor, causes the at least one processor to perform, after performing moving the related information of the second request matching the network resource identifier from the second queue to the first queue, further perform:
in a case where a length of the first queue meets a third preset condition, deleting related information of a first request meeting a fourth preset condition from the first queue.

20. The electronic device of claim 13, wherein the at least one program, when executed by the at least one processor, causes the at least one processor to perform, after performing updating the request data of the second request matching the network resource identifier, further perform:
in a case where the updated request data of the second request matching the network resource identifier does not meet a second preset condition, moving related information of the second request matching the network resource identifier to a head of the second queue.

21. The electronic device of claim 13, wherein the at least one program, when executed by the at least one processor, causes the at least one processor to further perform:
in a case where the second queue does not comprise the second request matching the network resource identifier, storing related information of the target request into the second queue; and
in a case where a length of the second queue meets a fifth preset condition, deleting related information of a second request at a tail of the second queue.
